(19) United States
(12) Patent Application Publication
(10) Pub. No.: US 2026/0138157 A1
(43) Pub. Date: May 21, 2026

(54) Classifier device for separating material to be classified into a fine material and a coarse material, classifier system and method for operating a classifier device

(71) Applicant: NETZSCH Trockenmahltechnik GmbH, Selb (DE)

(72) Inventor: Frank Winter, Mühlheim (DE)

(21) Appl. No.: 19/367,245

(22) Filed: Oct. 23, 2025

(30) Foreign Application Priority Data
Oct. 25, 2024 (DE) 10 2024 131 217.3

(51) Int. Cl. B07B 7/083; B07B 11/04

(52) U.S. Cl. CPC B07B 7/083; B07B 11/04

(57) ABSTRACT

A classifier device, in particular high-performance air classifier, for separating material to be classified into a fine material and a coarse material, the classifier device including: a stationary machine housing, which has a coarse material outlet; a static guide vane basket, which is arranged in the machine housing and which has a guide vane ring formed from a plurality of pivotable flap means; and wherein the guide vane ring further has a nozzle flap means, which is formed to convey a flushing gas volume flow in the direction of the coarse material outlet. The present invention further creates a classifier system with a classifier device of this type as well as a method for operating a classifier device of this type.

### TECHNICAL FIELD

The present invention relates to a classifier device, in particular a high-performance air classifier, for separating material to be classified into a fine material and a coarse material. The present invention further relates to a classifier system with a classifier device of this type and a method for operating a classifier device.

### BACKGROUND

Air classifiers, such as, for example, an air classifier according to the disclosure in the DE 44 18 195 A1, are usually operated so that material to be classified is supplied through a product supply line between a static guide vane basket and a classifier wheel arranged within the guide vane basket by means of a metering screw or the like. The guide vane basket and the classifier wheel are accommodated in a classifier housing. An operating medium in the form of classifier gas/steam is introduced via an operating medium supply line between the classifier housing and the guide vane basket and flows through the static guide vane basket. On the inner side of the guide vane basket, the material to be classified is flown through intensely by the operating medium, is dispersed and is transported to the classifier wheel for separating purposes. Lastly, the coarse material reaches through a rear classifier chamber, which is defined by a baffle, to the coarse material outlet in a helical motion.

Such air classifiers are often connected downstream from a mill, a drier or other process apparatuses. Downstream from these apparatuses, the material to be classified is mostly present so as to be dispersed in a gas flow or steam flow or generally fluid flow. In order to be able to carry out a classification, as it has been described above, the material to be classified has to be separated from the fluid flow by means of a filter.

During the classification in particular of adhesive products, it can happen that the coarse material outlet of the classifier clogs. Specifically, when being used in a classification method in the case of hygroscopic products, the discharge generally clogs. Flushing methods are known for this case, which heat up a flushing gas to at least 100° C. in order to avoid a condensation or a partial cool-down.

### SUMMARY

It is the object of the present invention to provide a classifier device as well as a method for operating a classifier device, which simplify a flushing of the coarse material outlet, and which work reliably so that a clogging does not occur.

According to the invention, this object is in each case solved by the subject matters of the independent claims.

According to a first aspect of the invention, a classifier device is provided, in particular a high-performance air classifier, for separating material to be classified into a fine material and a coarse material. The classifier device comprises a stationary machine housing, which has a coarse material outlet and a static guide vane basket arranged in the machine housing. The guide vane basket has a guide vane ring formed from a plurality of pivotable flap means. The guide vane ring further comprises a nozzle flap means, which is formed to convey a flushing gas volume flow in the direction of the coarse material outlet.

According to a second aspect of the invention, a classifier system is provided. The classifier system comprises a classifier device according to the first aspect of the invention and a flushing gas storage, which stores a flushing gas volume, and which is fluidically connected to the nozzle flap means via a supply line.

According to a third aspect of the invention, a method for operating a classifier device is provided, in particular a classifier device according to the first aspect of the invention. The method comprises:
determining an accumulation in a coarse material outlet of a stationary machine housing of the classifier device,
conveying a flushing gas volume flow for flushing the coarse material outlet with the help of a nozzle flap means arranged in a guide vane ring.

An idea on which the present invention is based consists in providing a discharge aid or the nozzle flap means, respectively, which can be operated with a flushing gas, and which does not intervene in a geometry of the guide vane basket thereby. A geometry of the nozzle flap means is thus integrated in the guide vane basket or the guide vane, respectively, the nozzle flap means is in particular a member of the guide vane ring. The nozzle flap means or discharge aid, respectively, blows the flushing gas volume flow essentially into the coarse material outlet.

It is an advantage of the present invention that a clogging of the coarse material outlet can be avoided by means of the nozzle flap means according to the invention. In particular in the case of classifier methods with hygroscopic products, the discharge or coarse material outlet, respectively, can be flushed in an advantageous manner, so that it does not clog.

Advantageous embodiments and further developments follow from the subclaims, which are dependent on the independent claims, as well as from the description with reference to the figures.

According to an embodiment of the present invention, the nozzle flap means is mounted so as to be pivotable about a pivot axis relative to the guide vane basket and the nozzle flap means is arranged closest to the coarse material outlet with respect to the plurality of pivotable flap means. The nozzle flap means can in particular be formed so as to be pivotable independently of the plurality of pivotable flap means. This does not rule out, however, that in some cases the nozzle flap means can have a position comparable to the plurality of pivotable flap means or can simultaneously be pivoted with the plurality of pivotable flap means. The position of the nozzle flap means can thus be set freely in order to be used optimally.

According to a further development of the present invention, the pivot axis of the nozzle flap means corresponds to a pivot axis of the plurality of pivotable flap means. The nozzle flap means can furthermore essentially have the same outer contour as the plurality of pivotable flap means. In some embodiments, a tapering end region can be formed in a flattened manner. In contrast, the tapering end region tapers in the case of the flap means.

According to a further embodiment of the present invention, the nozzle flap means has a flow-through channel, the flow outlet of which is arranged in an end region of the nozzle flap means and the flow inlet of which is connected to a supply line. In this way, the nozzle flap means can be supplied with the flushing gas volume flow from outside the machine housing.

For example, the flow inlet corresponds to the pivot axis of the nozzle flap means. This means that the flushing gas volume flow can flow along the pivot axis through the flow inlet into the flow-through channel. The flow-through channel can furthermore have a curvature, a deflection or the like, whereby the flow outlet is directed away from the pivot axis. For example, the flow outlet can be aligned so as to be altered by approximately 90° with respect to the flow inlet. In particular, the flow outlet can be aligned so as to be altered by approximately 90° with respect to the pivot axis.

The flow outlet can further be formed by several flow outlet openings, for example two or three flow outlet openings, wherein the flow-through channel branches off into the several flow outlet openings between the flow inlet and the flow outlet.

The classifier device can furthermore comprise a classifier wheel, which is arranged within the guide vane ring coaxially with respect to the guide vane basket.

According to a further embodiment of the present invention, the flushing gas volume flow is controlled by means of a control means in such a way that the flushing gas volume flow is to be released when opening a discharge flap of a sequenced lock arranged in the coarse material outlet. A necessary volume of relief can be ensured in this way in order to avoid a backflow.

According to a further embodiment of the present invention, the coarse material outlet has an opening for letting out the flushing gas volume flow, wherein the opening is arranged and aligned so that the flushing gas volume flow is directed at a discharge flap of a sequenced lock arranged in the coarse material outlet. In addition to the flushing gas volume flow through the nozzle flap means, a portion of the flushing gas volume flow can thus flow through the opening to the sequenced lock, in particular the discharge flap thereof. The discharge flap can be an upper discharge flap or a lower discharge flap thereby.

According to a further embodiment of the present invention, the classifier system further comprises a first valve means, which is integrated in the supply line upstream of the nozzle flap means and which is formed to control the flushing gas volume flow for the nozzle flap means. Alternatively, or additionally, the first valve means can be integrated downstream from the temperature control device or from the compressed air storage or downstream from both of them. For example, the first valve means can be formed as a magnetic valve.

According to a further embodiment of the present invention, the classifier system further comprises a temperature control device, which is integrated in the supply line upstream of the nozzle flap means. For example, the temperature control device can be formed to heat up or to cool the flushing gas volume flow, which flows past. The temperature control device can be formed, for example, as heating element. The temperature control device can have a temperature regulating unit thereby in order to control the flushing gas volume flow, which flows past, to a predetermined gas temperature. The predetermined gas temperature can be, for example, 100° C. or more.

According to a further embodiment of the present invention, the classifier system further comprises a pressurized compressed air storage, which is integrated in the supply line upstream of the nozzle flap means. The compressed air storage can have, for example, an overflow valve means. The compressed air storage can furthermore be arranged downstream from the temperature control device.

According to a further embodiment of the present invention, the classifier system further comprises a second valve means, which is arranged upstream of the opening, and which is formed to control the flushing gas volume flow for the discharge flap. The flushing gas volume flow or a portion thereof, respectively, can be branched off from the supply line thereby. The supply line can branch off, for example, upstream of the first valve means, so that the nozzle flap means and the opening can be supplied with the flushing gas volume flow independently of one another. For example, the second valve means can be formed as a magnetic valve.

According to a further embodiment of the present invention, the classifier system further comprises a control means, which controls the first valve means and/or the second valve means in such a way that the flushing gas volume flow is released when opening the discharge flap. This means that the control of the classifier system is clocked, for example, so that when opening the upper discharge flap of the sequenced lock, a gas pulse is triggered in order to ensure the necessary volume of relief in order to avoid a backflow.

According to a further embodiment of the present invention, a first valve means and/or a second valve means is controlled in such a way when conveying the flushing gas volume flow that the flushing gas volume flow is released when opening a discharge flap of a synchronized lock, which is arranged in the coarse material outlet. The flushing gas volume flow can flow through a flow-through channel of the nozzle flap means thereby. For example, the flow-through channel can be fed from a flushing gas storage via a supply line.

According to a further embodiment of the present invention, the method further comprises controlling the temperature of the flushing gas volume flow to a predetermined gas temperature before the flushing gas volume flow is conveyed in the direction of the coarse material outlet.

The above-described idea of the invention will be expressed below once again and additionally in other words. In simplified form, this idea relates to an adjustable discharge aid, which can be operated with flushing gas, if necessary, with hot gas or cold flushing gas, in order to provide a steam classification.

Where it makes sense, the above embodiments and further developments can be combined as desired. In particular, all features of the device can be transferred to the corresponding method, and vice versa. Further possible embodiments, further developments and implementations of the invention also comprise combinations, which are not mentioned explicitly, of features of the invention, which have been described above, or which will be described below with respect to the exemplary embodiments. In particular, the person of skill in the art will also add individual aspects as improvements or additions to the respective basic form of the present invention.

### BRIEF DESCRIPTION OF THE DRAWINGS

The present invention will be explained in more detail below on the basis of exemplary embodiments with reference to the enclosed figures of the drawings, in which:

FIG. 1 shows a schematic illustration of a classifier system with a classifier device according to an exemplary embodiment of the invention;

FIG. 2 shows a schematic front view in section of a classifier device for separating material to be classified into a fine material and a coarse material according to a further exemplary embodiment of the invention;

FIG. 3 shows a schematic side view in section of the classifier device from FIG. 2;

FIGS. 4A, 4B, 4C show a schematic illustration of a nozzle flap means according to a further exemplary embodiment of the invention, wherein the nozzle flap means is illustrated from the front side in FIG. 4A, in a cross section in FIG. 4B and in a lateral section in FIG. 4C; and

FIG. 5 shows a schematic flow chart of a method for operating a classifier device according to a further exemplary embodiment of the invention.

### DETAILED DESCRIPTION

Unless specified otherwise, identical, functionally identical elements, features and components and elements, features and components having the same effect, are in each case provided with the same reference numerals in the figures of the drawings.

Even though specific embodiments and further developments are illustrated and described in the present case, the person of skill in the art will prefer that a plurality of alternative and/or similar embodiments can replace the illustrated and described specific exemplary embodiments, without turning away from the scope of the present invention. This application is to generally cover all modifications or changes of the specific exemplary embodiments described herein.

The enclosed figures are to provide a further understanding of embodiments of the invention and, in connection with the description, serve the purpose of explaining principles and concepts of the invention. Other exemplary embodiments and many of the mentioned advantages follow with regard to the drawings. The drawings are to be understood only as schematic drawings and the elements of the drawings are not necessarily illustrated to scale. Terminology specifying a direction, such as, for instance, “top”, “bottom”, “left”, “right”, “above”, “below”, “horizontal”, “vertical”, “front”, “rear” and similar information is used only for explanatory purposes and does not serve the purpose of limiting the generality to specific designs, as shown in the figures.

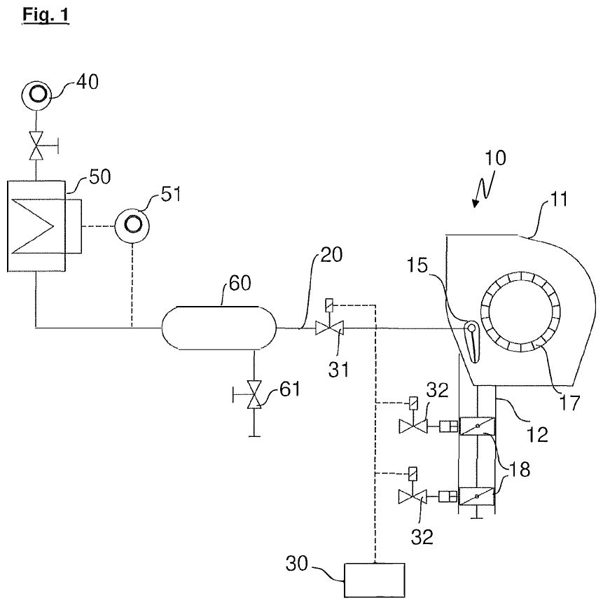

FIG. 1 shows a schematic illustration of a classifier system 1 with a classifier device 10 according to an exemplary embodiment of the invention.

The classifier system 1 comprises a classifier device 10. The classifier device 10 is formed for separating material to be classified into a fine material and a coarse material. It has a stationary machine housing with a coarse material outlet 12. A static guide vane basket, which has a guide vane ring formed from a plurality of pivotable flap means, is arranged in the machine housing. In addition, the guide vane ring comprises a nozzle flap means 15, which is formed to convey a flushing gas volume flow in the direction of the coarse material outlet 12.

The classifier system 1 furthermore comprises, for example, a supply line 20, a control means 30, a first valve means 31, a second valve means 32, a flushing gas storage 40, a temperature control device 50 and a pressurized compressed air storage 60.

The flushing gas storage 40 can store a flushing gas volume and can be fluidically connected via the supply line 20 to the nozzle flap means 15, the first valve means 31, the second valve means 32, the flushing gas storage 40, the temperature control device 50 and the compressed air storage 60.

The first valve means 31 can be integrated in the supply line 20 upstream of the nozzle flap means 15 thereby. It is formed to control the flushing gas volume flow for the nozzle flap means 15. Alternatively, or additionally, the first valve means 31 can be integrated downstream from the temperature control device 50 or from the compressed air storage 60 or downstream from both of them. For example, the first valve means 31 can be formed as a magnetic valve.

The temperature control device 50 can be integrated in the supply line 20 upstream of the nozzle flap means 15. For example, the temperature control device 50 can be formed to heat up or to cool the flushing gas volume flow, which flows past. The temperature control device 50 can be formed, for example, as heating element. The temperature control device 50 can have a temperature regulating unit 51 thereby in order to control the flushing gas volume flow, which flows past, to a predetermined gas temperature. The predetermined gas temperature can be, for example, 100° C. or more.

The compressed air storage 60 can be integrated in the supply line 20 upstream of the nozzle flap means 15. The compressed air storage 60 can have, for example, an overflow valve means 61. The compressed air storage 60 can furthermore be arranged downstream from the temperature control device 50.

The flushing gas volume flow can optionally be controlled by the control means 30 in such a way that the flushing gas volume flow is to be released when opening a discharge flap 18 of a sequenced lock arranged in the coarse material outlet 12. Alternatively, or additionally, the coarse material outlet 12 can have an opening for letting out the flushing gas volume flow, wherein the opening is arranged and aligned so that the flushing gas volume flow is directed at the discharge flap 18. In addition to the flushing gas volume flow through the nozzle flap means 15, a portion of the flushing gas volume flow can thus flow through the opening to the sequenced lock, in particular the discharge flap 18 thereof. The discharge flap 18 can be an upper discharge flap or a lower discharge flap thereby. The control means 30 can control the first valve means 31 and the second valve means 32 in such a way that the flushing gas volume flow is released when opening the discharge flap 18.

The second valve means 32 can be arranged upstream of the opening. It is formed to control the flushing gas volume flow for the discharge flap 18. The flushing gas volume flow or a portion thereof, respectively, can be branched off from the supply line 20 thereby. The supply line 20 can branch off, for example, upstream of the first valve means 31, so that the nozzle flap means 15 and the opening can be supplied with the flushing gas volume flow independently of one another. For example, the second valve means 32 can be formed as a magnetic valve.

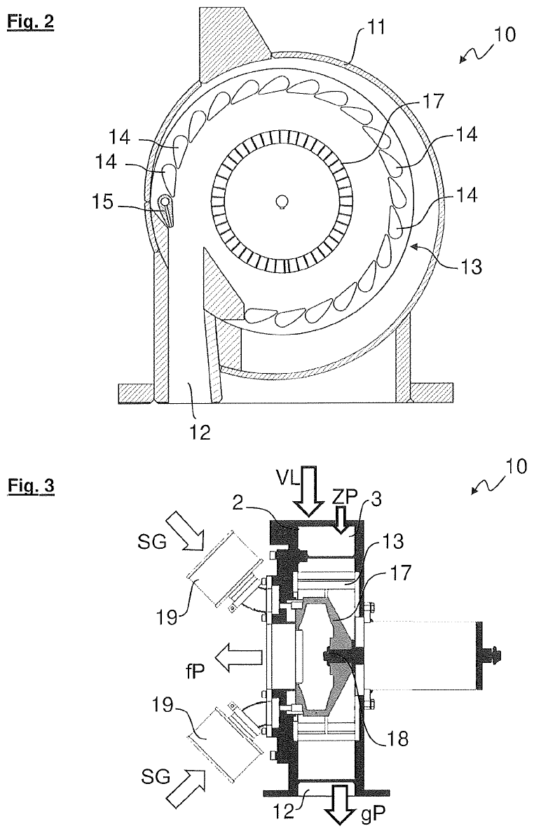

FIG. 2 shows a schematic front view in section of a classifier device 10 for separating material to be classified into a fine material and a coarse material according to a further exemplary embodiment of the invention. FIG. 3 shows a schematic side view in section of the classifier device 10 from FIG. 2.

The classifier device 10 is formed, for example, as a high-performance air classifier and comprises a stationary machine housing 11 with a coarse material outlet 12, a static guide vane basket 13 and a guide vane ring with a plurality of pivotable flap means 14 and with a nozzle flap means 15.

The static guide vane basket 13 is arranged in the machine housing 11. The nozzle flap means 15 is formed to convey a flushing gas volume flow in the direction of the coarse material outlet 12. This means that the nozzle flap means 15 blows the flushing gas volume flow essentially into the coarse material outlet 12, as is illustrated in an exemplary manner by the position and alignment of the nozzle flap means 15 in FIG. 2.

The nozzle flap means 15 can optionally be mounted so as to be pivotable about a pivot axis relative to the guide vane basket 13. The nozzle flap means 15 can furthermore be is arranged closest to the coarse material outlet 12 with respect to the plurality of pivotable flap means 14. The nozzle flap means 15 can in particular be formed so as to be pivotable independently of the plurality of pivotable flap means 14. The position of the nozzle flap means 15 can be set freely thereby.

For example, the pivot axis of the nozzle flap means 15 can correspond to a pivot axis of the plurality of pivotable flap means 14. The nozzle flap means 15 can furthermore essentially have the same outer contour as the plurality of pivotable flap means 14.

The classifier device 10 can furthermore comprise a classifier wheel 17, which is arranged within the guide vane ring coaxially with respect to the guide vane basket 13.

The coarse material outlet 12 can optionally have an opening for letting out the flushing gas volume flow, wherein the opening is arranged and aligned so that the flushing gas volume flow is directed at a discharge flap 18 (see FIG. 1) of a sequenced lock arranged in the coarse material outlet 12. In addition to the flushing gas volume flow through the nozzle flap means 15, a portion of the flushing gas volume flow can thus flow through the opening to the sequenced lock, in particular the discharge flap 18 thereof.

In consideration of the exemplary classifier device 10, a powdery intermediate product ZP can be supplied via a product addition 3 to the classifier device 10 from the top. The supply of the necessary process air VL, which entrains the powdery intermediate product ZP supplied via the product addition 3 and guides it through a plurality of settable guide vane gaps of the guide vane basket 13, whereby the intermediate product ZP is dispersed, can take place through a classifier air inlet 2. For example, a protective gas can be used as process air VL.

The intermediate product ZP dispersed in this way can be guided via the classifier wheel 17, the speed of which can be set continuously, wherein the separation of the particle sizes takes place either into target and coarse material or into target and ultra-fine material. The ultra-fine particles fP leave the classifier device 10 via the classifier wheel 17 installed with horizontal shaft 18 in the center of the classifier device 10. The coarse particles gP are rejected by the classifier wheel 17 and are discharged through the machine housing 11, which is formed in a helical manner, for example on the rear side via the coarse material outlet 12 on the underside of the machine housing 11. In the case of difficult separation tasks, the discharge of the coarse particles gP can be regulated via the position of the nozzle flap means 15 and the purity of the coarse particles gP can thus be influenced. The particles of the target size leave the classifier device 10 together with the coarse material via the coarse material outlet 12. The ultra-fine particles fP were separated from the particles of the target size and thus do not form a part of the fraction, which leaves the classifier device 10 via the coarse material outlet 12.

The regulation of the desired target particle size in particular takes place hereby via a regulation of the gas flow of the process air VL and/or of the speed of the classifier wheel 17. A higher gas flow and/or a lower speed lead to a coarser product, while a lower gas flow and/or a higher speed lead to a finer product.

In addition, FIG. 3 shows at least two cracked gas supplies 19, which are necessary to flush the gap between fine material outlet and the classifier wheel 17 with a so-called cracked gas SG. However, embodiments with only one cracked gas supply 19 are also possible. It is avoided with this flushing that particles accumulate in the classifier wheel 17 and/or the gap between the fine material outlet and the classifier wheel 17 and clog it. The flushing takes place by means of a fluid, which is suitable for this purpose, in a preferred embodiment by means of protective gas.

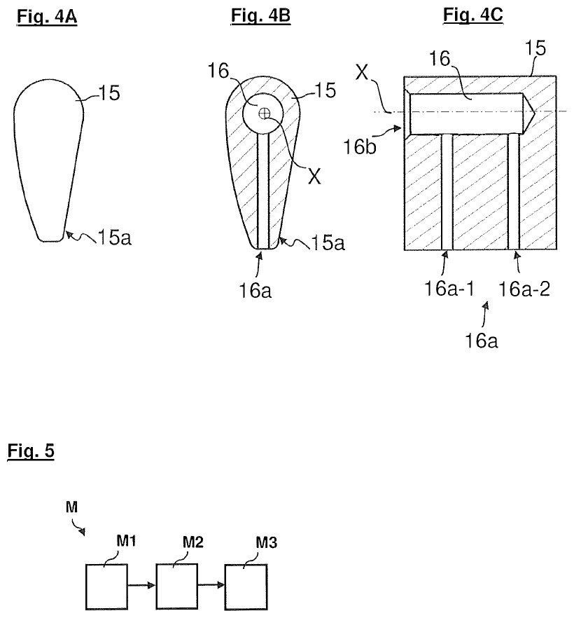

FIGS. 4A, 4B, 4C show a schematic illustration of a nozzle flap means 15 according to a further exemplary embodiment of the invention, wherein the nozzle flap means 15 is illustrated from the front side in FIG. 4A, in a cross section in FIG. 4B and in a lateral section in FIG. 4C.

As is illustrated in FIGS. 4B and 4C, the nozzle flap means 15 can have a flow-through channel 16, the flow outlet 16a of which is arranged in an end region 15a of the nozzle flap means 15 and the flow inlet 16b of which is connected to a supply line 20. In this way, the nozzle flap means 15 can be supplied with the flushing gas volume flow from outside the machine housing 11. For example, the flow inlet 16b corresponds to the pivot axis X of the nozzle flap means 15. This means that the flushing gas volume flow can flow along the pivot axis X through the flow inlet 16b into the flow-through channel 16.

The flow-through channel can furthermore have a curvature, a deflection or the like, whereby the flow outlet 16a is directed away from the pivot axis X. For example, the flow outlet 16a can be aligned so as to be altered by approximately 90° with respect to the flow inlet 16b. In particular, the flow outlet 16a can be aligned so as to be altered by approximately 90° with respect to the pivot axis X.

The flow outlet 16a can further be formed by two flow outlet openings 16a-1, 16a-2, as it is illustrated in an exemplary manner in FIG. 4C. The flow-through channel 16 can branch off into the two flow outlet openings 16a-1, 16a-2 between the flow inlet 16b and the flow outlet 16a thereby.

In some embodiments, a tapering end region 15a can be formed in a flattened manner. In contrast, the tapering end region tapers at the flap means 14.

FIG. 5 shows a schematic flow chart of a method M for operating a classifier device 10 according to a further exemplary embodiment of the invention. The classifier device 10 can be formed, for example, like the classifier device from FIGS. 2 and 3.

The method comprises, for example, the steps of determining M1 an accumulation, controlling the temperature M2 of the flushing gas volume flow and conveying M3 a flushing gas volume flow.

In step M1, an accumulation in the coarse material outlet 12 of the stationary machine housing 11 of the classifier device 10 is determined.

In step M2, the temperature of the flushing gas volume flow is controlled to a predetermined gas temperature before the flushing gas volume flow is conveyed in the direction of the coarse material outlet 12.

In step M3, the flushing gas volume flow for flushing the coarse material outlet 12 is conveyed with the help of the nozzle flap means 15, which is arranged in a guide vane ring. The first valve means 31 and/or the second valve means 32 can be controlled in such a way thereby that the flushing gas volume flow is released when opening the discharge flap 18 of the sequenced lock arranged in the coarse material outlet 12. The flushing gas volume flow can flow through the flow-through channel 16 of the nozzle flap means 15 thereby. For example, the flow-through channel 16 can be fed from the flushing gas storage 40 via the supply line 20.

Different features have been combined in one or several examples in the preceding detailed description in order to improve the stringency of the illustration. It should be clear thereby, however, that the above description is only of an illustrative, but in no way of a limiting nature. It serves the purpose of covering all alternatives, modifications and equivalents of the different features and exemplary embodiments. Many other examples will be clear immediately and directly to the person of skill in the art based on his/her expert knowledge in consideration of the above description.

The exemplary embodiments have been selected and described in order to be able to present the principles, on which the invention is based, and its applications in practice in the best possible way. Experts can thus optimally modify and use the invention and its different exemplary embodiments with regard to the intended purpose. In the claims as well as the description, the terms “including” and “having” are used as neutral terminology for the corresponding terms “comprising”. A use of the terms “a” and “an” is to furthermore not generally rule out a plurality of features and components described in this way.

1. A classifier device, in particular high-performance air classifier, for separating material to be classified into a fine material and a coarse material, the classifier device comprising:
a stationary machine housing, which has a coarse material outlet;
a static guide vane basket, which is arranged in the machine housing and which has a guide vane ring formed from a plurality of pivotable flap means; and
wherein the guide vane ring further has a nozzle flap means, which is formed to convey a flushing gas volume flow in the direction of the coarse material outlet.

2. The classifier device according to claim 1, wherein the nozzle flap means is mounted so as to be pivotable about a pivot axis relative to the guide vane basket and wherein the nozzle flap means is arranged closest to the coarse material outlet with respect to the plurality of pivotable flap means.

3. The classifier device according to claim 2, wherein the pivot axis of the nozzle flap means corresponds to a pivot axis of the plurality of pivotable flap means.

4. The classifier device according to claim 1, wherein the nozzle flap means has a flow-through channel, the flow outlet of which is arranged in an end region of the nozzle flap means and the flow inlet of which is connected to a supply line.

5. The classifier device according to claim 1, wherein the flushing gas volume flow is controlled by means of a control means in such a way that the flushing gas volume flow is to be released when opening a discharge flap of a synchronized lock, which is arranged in the coarse material outlet.

6. The classifier device according to claim 1, wherein the coarse material outlet has an opening for letting out the flushing gas volume flow, wherein the opening is arranged and aligned so that the flushing gas volume flow is directed at a discharge flap of a sequenced lock arranged in the coarse material outlet.

7. A classifier system comprising:
a classifier device, in particular high-performance air classifier, for separating material to be classified into a fine material and a coarse material, the classifier device including:
a stationary machine housing, which has a coarse material outlet;
a static guide vane basket, which is arranged in the machine housing and which has a guide vane ring formed from a plurality of pivotable flap means; and
wherein the guide vane ring further has a nozzle flap means, which is formed to convey a flushing gas volume flow in the direction of the coarse material outlet; and
a flushing gas storage, which stores a flushing gas volume, and which is fluidically connected to the nozzle flap means via a supply line.

8. The classifier system according to claim 7, further comprising a first valve means, which is integrated in the supply line upstream of the nozzle flap means and which is formed to control the flushing gas volume flow for the nozzle flap means.

9. The classifier system according to claim 7, further comprising a temperature control device, which is integrated in the supply line upstream of the nozzle flap means.

10. The classifier system according to claim 7, further comprising a pressurized compressed air storage, which is integrated in the supply line upstream of the nozzle flap means.

11. The classifier system according to claim 7, further comprising a second valve, which is arranged upstream of the opening and which is formed to control the flushing gas volume flow for the discharge flap.

12. The classifier system according to claim 7, further comprising a control means, which controls the first valve means and/or the second valve means in such a way that the flushing gas volume flow is released when opening the discharge flap.

13. A method for operating a classifier device, for separating material to be classified into a fine material and a coarse material, including:
a stationary machine housing, which has a coarse material outlet;
a static guide vane basket, which is arranged in the machine housing and which has a guide vane ring formed from a plurality of pivotable flap means; and
wherein the guide vane ring further has a nozzle flap means, which is formed to convey a flushing gas volume flow in the direction of the coarse material outlet, comprising:
determining an accumulation in a coarse material outlet of a stationary machine housing of the classifier device;
conveying a flushing gas volume flow for flushing the coarse material outlet with the help of a nozzle flap means arranged in a guide vane ring.

14. The method according to claim 13, wherein a first valve means and/or a second valve means is controlled in such a way when conveying the flushing gas volume flow that the flushing gas volume flow is released when opening a discharge flap of a synchronized lock, which is arranged in the coarse material outlet.

15. The method according to claim 13, further comprising:
controlling the temperature of the flushing gas volume flow to a predetermined gas temperature before the flushing gas volume flow is conveyed in the direction of the coarse material outlet.

16. The classifier device according to claim 2, wherein the nozzle flap means has a flow-through channel, the flow outlet of which is arranged in an end region of the nozzle flap means and the flow inlet of which is connected to a supply line.

17. The classifier device according to claim 2, wherein the flushing gas volume flow is controlled by means of a control means in such a way that the flushing gas volume flow is to be released when opening a discharge flap of a synchronized lock, which is arranged in the coarse material outlet.

18. The classifier device according to claim 2, wherein the coarse material outlet has an opening for letting out the flushing gas volume flow, wherein the opening is arranged and aligned so that the flushing gas volume flow is directed at a discharge flap of a sequenced lock arranged in the coarse material outlet.

19. The classifier system according to claim 8, further comprising a temperature control device, which is integrated in the supply line upstream of the nozzle flap means.

20. The classifier system according to claim 8, further comprising a pressurized compressed air storage, which is integrated in the supply line upstream of the nozzle flap means.
